(19) United States
(12) Patent Application Publication
(10) Pub. No.: US 2009/0237650 A1
(43) Pub. Date: Sep. 24, 2009

(54) Optical unit and measuring instrument

(75) Inventors: Seiji Shimokawa, Kawasaki-shi (JP); Tatsuya Nagahama, Kawasaki-shi (JP); Eisuke Moriuchi, Kawasaki-shi (JP)

Correspondence Address: OLIFF & BERRIDGE, PLC, P.O. BOX 320850, ALEXANDRIA, VA, 22320-4850, US

(73) Assignee: MITUTOYO CORPORATION, Kawasaki-Shi (JP)

(21) Appl. No.: 12/379,750

(22) Filed: Feb. 27, 2009

(30) Foreign Application Priority Data
Mar. 19, 2008 (JP) 2008-071795

(51) Int. Cl. G01B 11/27

(52) U.S. Cl. 356/138

(57) ABSTRACT

An optical unit includes: an objective lens; an imaging lens that is arranged in the optical axis of the objective lens and images a light beam output from the objective lens; a plurality of afocal optical systems that are arranged between the objective lens and the imaging lens and have different afocal magnifications; and a switch that shifts either one of the afocal optical systems to be aligned with the optical axis of the objective lens.

### BACKGROUND OF THE INVENTION

1. Field of the Invention

The present invention relates to an optical unit and a measuring instrument. Specifically, it relates to an optical unit and a measuring instrument that can change optical magnification.

2. Description of Related Art

Conventionally, various methods for changing optical magnification have been used in an image measuring instrument, an optical instrument and the like.

An optical system that forms an image with the use of an objective lens 1 and an imaging lens 2 as shown in FIG. 3 is called an infinity-correction optical system. When a focal length of the objective lens 1 is f1 and a focal length of the imaging lens 2 is f2, optical magnification β is expressed by the formula:

β=f2/f1

When the focal length f1 of the objective lens 1 is fixed, the optical magnification β can be changed by changing the focal length f2 of the imaging lens 2.

In order to change the focal length f2 of the imaging lens 2, a lens switching method that switches the imaging lens 2 and an optical path switching method that switches an optical path from the objective lens 1 are known.

The former lens switching method shifts imaging lenses 2A and 2B having different focal lengths f2 and f3 respectively to be aligned with an optical axis of the objective lens 1 with the use of a slide mechanism 3 which slides in a direction perpendicular to the optical axis of the objective lens 1 as shown in FIG. 4, or with the use of a turret mechanism (see, for instance, Document 1: JP-A-09-304682).

The latter optical path switching method branches a light beam from the objective lens 1 into two optical paths by using two half mirrors as shown in FIG. 5. In the respective branched optical paths, the imaging lenses 2A and 2B having different focal lengths f2 and f3 respectively are arranged. In the respective branched optical paths, mechanical shutters 6 and 7 are arranged. Switching the mechanical shutters 6 and 7 switches the respective optical paths to switch the magnification.

However, the conventional magnification switching methods have disadvantage as follows.

In the former lens switching method, the mechanical accuracy (including repeatability) of the slide mechanism and the turret mechanism is limited, so that optical axes of the imaging lenses 2A and 2B 1 are misaligned with the optical axis of the objective lens in switching the magnification. Consequently, the focal position is not at the center of the imaging lens, so that a highly accurate measurement is not expected.

In the latter optical path switching method, the imaging lenses 2A and 2B do not move, so that the optical axes of the imaging lenses 2A and 2B are not misaligned with the optical axis of the objective lens 1 in switching the magnification. However, the optical path requires to be branched by the half mirrors 4 and 5, resulting in decrease in light quantity. In addition, an imaging device such as a camera requires to be arranged correspondingly to each of the imaging lenses 2A and 2B, resulting in a large economic burden.

### SUMMARY OF THE INVENTION

An object of the invention is to solve the above disadvantages and to provide an optical unit and a measuring instrument that minimize influence caused by a deviation between optical axes in switching the magnification so that a highly accurate measurement can be achieved without incurring economic burden.

An optical unit of the invention includes: an objective lens; an imaging lens that is arranged on the optical axis of the objective lens and images a light beam output from the objective lens; a plurality of afocal optical systems that are arranged between the objective lens and the imaging lens and have different afocal magnifications; and a switch that shifts one of the afocal optical systems into the optical axis of the objective lens.

According to such an arrangement, one of the plurality of the afocal optical systems is shifted to be aligned with the optical axis of the objective lens by the switching operation with the switch in switching the magnification. When a focal length of the objective lens is f1, a focal length of the imaging lens is f2 and an afocal magnification of the afocal optical system is α, an optical magnification β of the optical unit is expressed by the formula:

β=(f2/f1)×α

Accordingly, by the switching operation with the switch that the afocal optical systems having different magnifications are shifted to be aligned with the optical axis of the objective lens, the optical magnifications can be switched.

Even if the optical axes of the afocal optical systems are misaligned with the optical axes of the objective lens and the imaging lens in the switching operation, parallel light beams from the afocal optical systems always image at the center of the optical axis of the imaging lens, thereby minimizing a deviation of the focus from the center of the imaging lens. Accordingly, the highly accurate measurement can be achieved.

Further, since the optical path is not branched, the light quantity does not decrease and the economic burden incurred by additionally mounting an imaging device such as a camera is small.

In the optical unit of the above aspect of the invention, it is preferable that the switch is provided by one of a slide mechanism that linearly moves the afocal optical systems in a direction substantially perpendicular to the optical axis of the objective lens and a turret mechanism that moves the afocal optical systems in an arc.

According to such an arrangement, even if the slide mechanism and the turret mechanism do not have a high mechanical accuracy including repeatability, influence caused by a deviation of the optical axis can be reduced, so that the slide mechanism and the turret mechanism can be manufactured easily and with low cost. Consequently, the cost of the optical unit can be reduced as a whole.

The measuring instrument according to another aspect of the invention includes one of the optical units described above.

Herein, the measuring instrument includes an image measuring instrument and an optical measuring microscope.

According to such an arrangement, an image measuring instrument and an optical measuring microscope that can achieve the above advantage can be provided.

### BRIEF DESCRIPTION OF THE DRAWINGS

FIG. 1 shows an exemplary embodiment of an optical unit of the invention.

FIG. 2 is an illustration showing switched magnification in the above embodiment.

FIG. 3 shows an infinity-correction optical system.

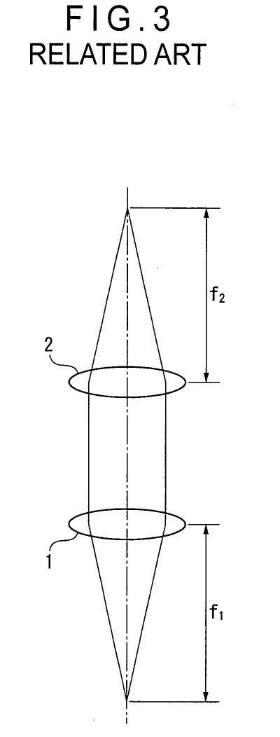

FIG. 4 shows a conventional lens-switching method in switching the magnification.

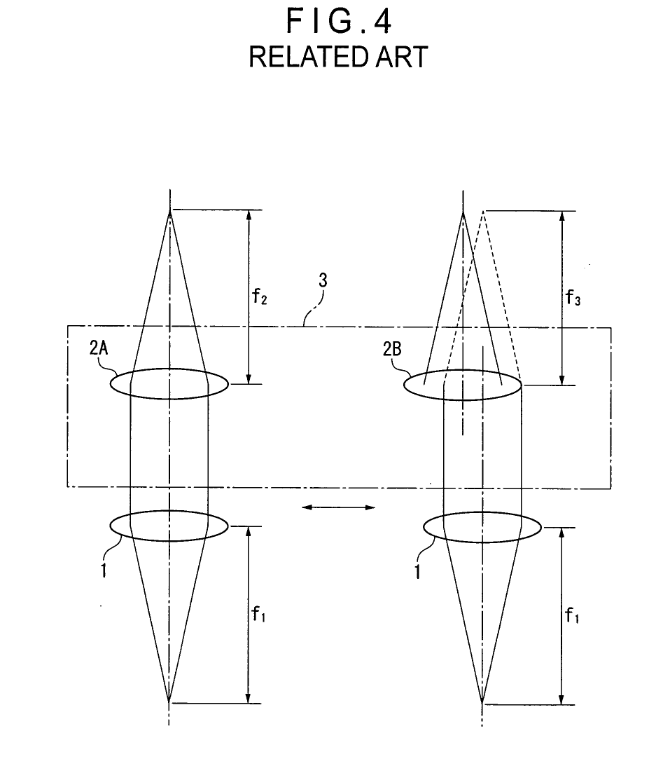

FIG. 5 shows a conventional optical path switching method in switching the magnification.

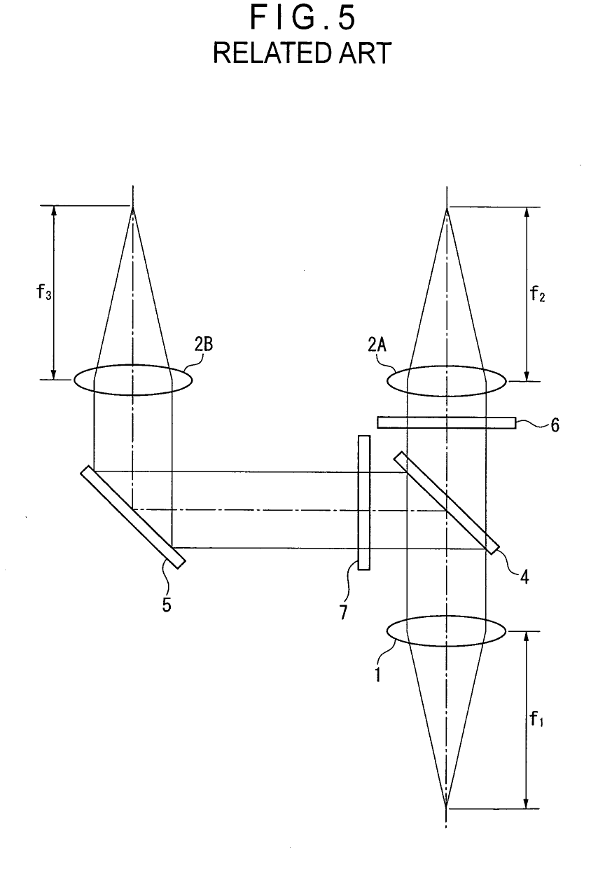

### DETAILED DESCRIPTION OF PREFERRED EMBODIMENT(S)

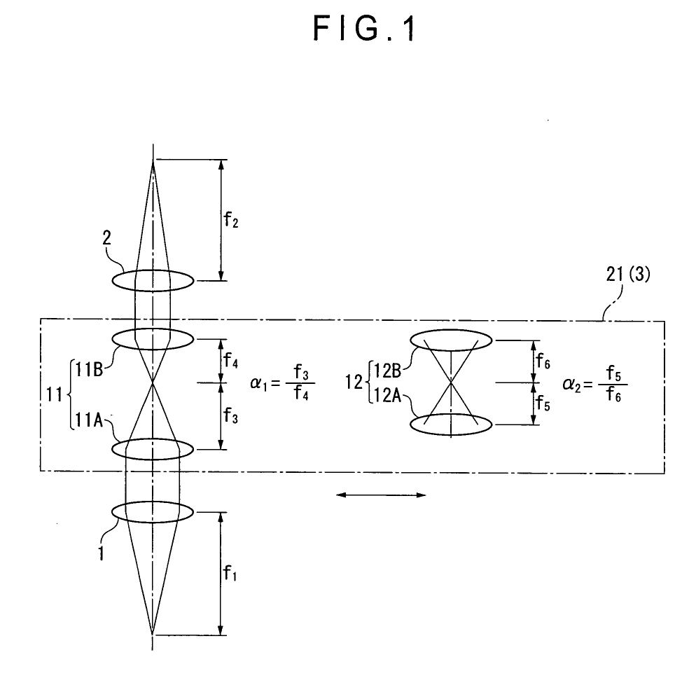

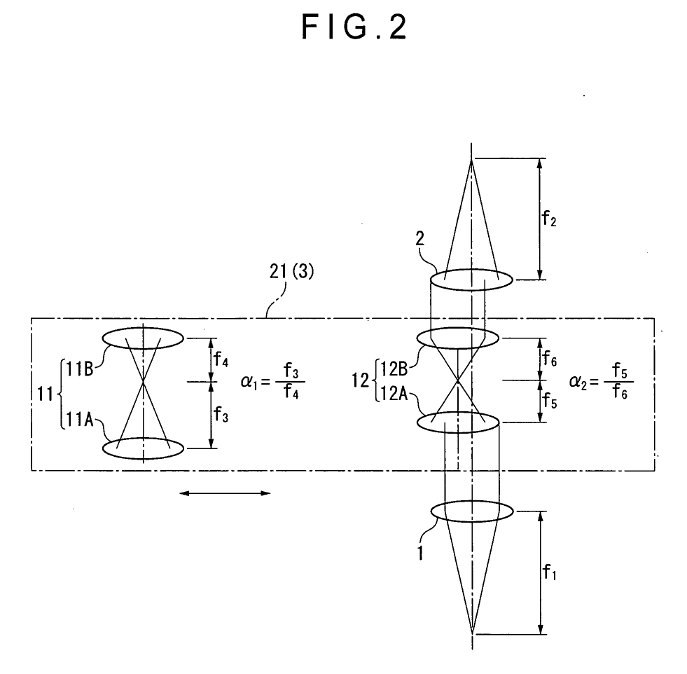

### Explanation of Overall Structure (See FIGS. 1 and 2)

FIG. 1 shows an exemplary embodiment of an optical unit of the invention and FIG. 2 is an illustration showing switched magnification.

An optical unit includes: an objective lens 1; an imaging lens 2 that is arranged on an optical axis of the objective lens 1 and images a light beam output from the objective lens 1; a plurality of afocal optical systems 11 and 12 that are arranged between the objective lens 1 and the imaging lens 2 and have different afocal magnifications; and a switch 21 that shifts either one of the afocal optical systems 11 and 12 into the optical axis of the objective lens 1.

The objective lens 1 and the imaging lens 2 are coaxial and are spaced apart with each other by an interval. In other words, the objective lens 1 and the imaging lens 2 are arranged space apart by an interval so that the optical axis of the imaging lens 2 is aligned with the optical axis of the objective lens 1.

Afocal optical systems 11 and 12 include a first afocal optical system 11 and a second afocal optical system 12, both of which have different afocal magnifications.

The first afocal optical system 11 includes a convex lens 11A that is arranged on the side at the objective lens 1 and has a focal length f3 and a convex lens 11B that is arranged on the side at the imaging lens 2 and has a focal length f4. In short, the first afocal optical system 11 is provided by a Kepler type afocal optical system consisting of two convex lenses. The convex lenses 11A and 11B are arranged so that a front focal position of the convex lens 11B coincides with a back focal position of the convex lens 11A. Accordingly, an afocal magnification α1 of the first afocal optical system 11 is expressed by the formula:

α1=f3/f4

The second afocal optical system 12 includes a convex lens 12A that is arranged on the side at the objective lens 1 and has a focal length f5 and a convex lens 12B that is arranged on the side at the imaging lens 2 and has a focal length f6. In short, the second afocal optical system 12 is provided by a Kepler type afocal optical system consisting of two convex lenses. The convex lenses 12A and 12B are arranged so that a front focal position of the convex lens 12B coincides with a back focal position of the convex lens 12A. Accordingly, an afocal magnification α2 of the second afocal optical system 12 is expressed by the formula:

α2=f5/f6

A switch 21 includes a slide mechanism 3 that linearly slides the first afocal optical system 11 and the second afocal optical system 12 in a direction substantially perpendicular to the optical axis of the objective lens 1.

A known slide mechanisms may be used for the slide mechanism 3. For example, the slide mechanism includes a slider that slides in a direction perpendicular to the optical axis of the objective lens 1 and a guiding mechanism that guides the slider, where the first afocal optical system 11 and the second afocal optical system 12 are arranged in the sliding direction of the slider with an interval. Accordingly, when the slider is slid in the direction perpendicular to the optical axis of the objective lens 1, either one of afocal optical systems 11 and 12 is shifted into the optical axis of the objective lens 1.

Though not shown in FIGS. 1 and 2, an illumination light may be incident on the half mirrors, for instance, from the direction perpendicular to the optical axis of the objective lens 1 by inserting the half mirrors between the objective lens 1 and the afocal optical systems 11 and 12.

Further, for an imaging measuring instrument, an imaging device such as CCD camera is arranged at an imaging position of the imaging lens 2.

### Magnification Switching Operation

In a state of FIG. 1 where the afocal magnification of the first afocal optical system 11 is α1, the magnification β1 of the optical unit is expressed by the formula:

β1=(f2/f1)×α1

In this state, the slide mechanism 3 is slid to shift the second afocal optical system 12 into the optical axis of the objective lens 1.

Consequently, as shown in FIG. 2, the optical axis of the second optical system 12 is sometimes misaligned with the optical axis of the objective lens 1. Even if the optical axis of the second optical system 12 is misaligned with the optical axis of the objective lens 1, a parallel light beam from the second optical system 12 always images at the center of the optical axis of the imaging lens 2, thereby minimizing a deviation of the focus from the center of the imaging lens.

In a state of FIG. 2 where the afocal magnification of the second afocal optical system 12 is α2, the magnification α2 of the optical unit is expressed by the formula:

β2=(f2/f1)×α2

### Advantage of Embodiment

In the above embodiment, the first afocal optical system 11 and the second optical system 12, both of which have different magnifications, are arranged between the objective lens 1 and the imaging lens 2 with the switch 21 provided for shifting either one of the first afocal optical system 11 and the second afocal optical system 12 into the optical axis of the objective lens 1. By switching operation with the switch 21 to shift either one of the first afocal optical system 11 and the second optical system 12 into the optical axis of the objective lens 1, the magnification can be switched.

Even if the optical axes of the afocal optical systems 11 and 12 are misaligned with the optical axes of the objective lens 1 and the imaging lens 2, parallel light beams from the afocal optical systems 11 and 12 always image at the center of the optical axis of the imaging lens 2, thereby minimizing a deviation of the focus from the center of the imaging lens. Accordingly, highly accurate measurement can be achieved.

Further, the optical unit of the above embodiment does not require branched optical path, so that light quantity does not decrease and the economic burden by additionally mounting an imaging device such as a camera is small.

Moreover, according to an arrangement of the image measuring instrument provided with the above optical unit, a highly accurate measuring instrument can be economically provided.

### Modifications

The invention is not limited to the forgoing exemplary embodiment, but includes modifications, improvements and the like within the range in which an object of the invention can be achieved.

In the forgoing exemplary embodiment, the afocal optical systems 11 and 12 are provided by a Kepler type consisting of the two convex lenses 11A and 11B and 12A and 12B, but the structure is not limited to this. For example, a Galileo type afocal optical system consisting of a concave lens and convex lens may be used.

Further, the afocal optical systems 11 and 12 are not limited to ones consisting of two lenses, but may be a zoom optical system or may be provided within the objective lens 1 and/or the imaging lens 2.

In the forgoing exemplary embodiment, the two afocal optical systems 11 and 12 are provided, either one of which is switched onto the optical axis of the objective lens 1. However, three or more afocal optical systems may be provided.

In the forgoing exemplary embodiment, the switch 21 includes the slide mechanism 3, but the structure is not limited to this. For example, the turret mechanism may be used to move the afocal optical systems 11 and 12 in an arc to shift. If the turret mechanism is used to shift the afocal optical system as the number thereof increases, more afocal optical systems can be provided in a small space.

The entire disclosure of Japanese Patent Application No. 2008-071795, filed Mar. 19, 2008 is expressly incorporated by reference herein.

What is claimed is:

1. An optical unit, comprising:
an objective lens;
an imaging lens that is arranged on an optical axis of the objective lens and images a light beam output from the objective lens;
a plurality of afocal optical systems that are arranged between the objective lens and the imaging lens and have different afocal magnifications; and
a switch that shifts one of the afocal optical systems into the optical axis of the objective lens.

2. The optical unit according to claim 1,
wherein the switch is provided by either one of a slide mechanism that linearly moves the afocal optical systems in a direction substantially perpendicular to the optical axis of the objective lens, and a turret mechanism that moves the afocal optical systems in an arc.

3. A measuring instrument, comprising the optical unit according to claim 1.

4. A measuring instrument, comprising the optical unit according to claim 2.
